(19) United States
(12) Patent Application Publication
(10) Pub. No.: US 2023/0236289 A1
(43) Pub. Date: Jul. 27, 2023

(54) CONTROL DEVICE, CONTROL METHOD, AND STORAGE MEDIUM

(71) Applicant: TOYOTA JIDOSHA KABUSHIKI KAISHA, Toyota-shi (JP)

(72) Inventors: Katsuma ISHIZAKI, Toyota-shi (JP); Takuto Niwa, Toyota-shi (JP)

(73) Assignee: TOYOTA JIDOSHA KABUSHIKI KAISHA, Toyota-shi (JP)

(21) Appl. No.: 18/074,791

(22) Filed: Dec. 5, 2022

(30) Foreign Application Priority Data
Jan. 21, 2022 (JP) 2022-007800

(51) Int. Cl. G01S 7/40; B60S 1/08

(52) U.S. Cl. CPC G01S 7/4047; B60S 1/0866

(57) ABSTRACT

A control device for a heater that is installed in at least a portion of a member constituting a part of an outer surface of a vehicle and that melts snow of the member by generating heat through energization, the portion through which a radio wave of a radar installed in the vehicle is transmitted, includes: a dirt determination value calculation unit that calculates a dirt determination value for determining whether dirt adheres to an outer surface of the portion of the member based on a reception level of a radio wave received by the radar; and a heater control unit that executes heating control to energize the heater when an outside air temperature is in a predetermined low temperature range and the dirt determination value is equal to or larger than a predetermined threshold value.

### CROSS-REFERENCE TO RELATED APPLICATION

This application claims priority to Japanese Patent Application No. 2022-007800 filed on Jan. 21, 2022, incorporated herein by reference in its entirety.

### BACKGROUND

### 1. Technical Field

The present disclosure relates to a control device, a control method, and a storage medium, and in particular, relates to technology suitable for controlling a heater that melts snow.

### 2. Description of Related Art

A vehicle may be equipped with a millimeter wave radar that detects the relative position and the relative speed of an object relative to the vehicle by irradiating millimeter wave band radio waves to the object around the vehicle and receiving the reflected waves. When wet snow with high water content adheres to and accumulates on the radome and the front cover of the millimeter wave radar, the wet snow affects the radio wave transmissivity, thereby causing degradation of the detection performance of the millimeter wave radar.

As a technology for suppressing the degradation of radar performance due to such snow accumulation, Japanese Unexamined Patent Application Publication No. 2000-321348 (JP 2000-321348 A) discloses a device that melts snow by installing a heater in the radome, determining whether there is snowfall and determining snow quality based on the outside air temperature and the operation status of the wiper device, and activating the heater based on the determination results.

### SUMMARY

In the device disclosed in JP 2000-321348 A, when the outside air temperature is below a predetermined temperature and the wiper device is operating, the heater is activated assuming that snow adheres to the radome. However, even when the outside air temperature is below the predetermined temperature, drivers often do not activate the wiper device when the snow has stopped or when dry snow that is difficult to adhere is falling.

For this reason, in the device described in JP 2000-321348 A, for example, when the driver deactivates the wiper device in the case where the snow has stopped at the time of using the vehicle even when wet snow accumulates on the radome before the vehicle is used, or in the case where dry snow is falling, the heater cannot be activated properly even though snow melting is required, which may result in degradation of the detection performance of the radar.

The present disclosure has been made to solve the above issues. That is, one of the objectives of the present disclosure is to effectively suppress degradation of the radar detection performance.

A device according to the present disclosure is a control device (40) for a heater (30) that is installed in at least a portion of a member (FP) constituting a part of an outer surface of a vehicle (10) and that melts snow of the member (FP) by generating heat through energization, the portion through which a radio wave of a radar (20) installed in the vehicle (10) is transmitted, and includes: a dirt determination value calculation unit (41) that calculates a dirt determination value (CD) for determining whether dirt adheres to an outer surface of the portion of the member (FP) based on a reception level of a radio wave received by the radar (20); and a heater control unit (42, 43) that executes heating control to energize the heater (30) when an outside air temperature (T) is in a predetermined low temperature range and the dirt determination value (CD) is equal to or larger than a predetermined threshold value (CDth).

A method according to the present disclosure is a control method for a heater (30) that is installed in at least a portion of a member (FP) constituting a part of an outer surface of a vehicle (10) and that melts snow of the member (FP) by generating heat through energization, the portion through which a radio wave of a radar (20) installed in the vehicle (10) is transmitted, and includes: calculating a dirt determination value (CD) for determining whether dirt adheres to an outer surface of the portion of the member (FP) based on a reception level of a radio wave received by the radar (20); and executing heating control to energize the heater (30) when an outside air temperature (T) is in a predetermined low temperature range and the dirt determination value (CD) is equal to or larger than a predetermined threshold value (CDth).

A storage medium according to the present disclosure stores a program for causing a computer to execute processes, the computer being included in a control device (40) for a heater (30) that is installed in at least a portion of a member (FP) constituting a part of an outer surface of a vehicle (10) and that melts snow of the member (FP) by generating heat through energization, the portion through which a radio wave of a radar (20) installed in the vehicle (10) is transmitted, and the processes includes: calculating a dirt determination value (CD) for determining whether dirt adheres to an outer surface of the portion of the member (FP) based on a reception level of a radio wave received by the radar (20); and executing heating control to energize the heater (30) when an outside air temperature (T) is in a predetermined low temperature range and the dirt determination value (CD) is equal to or larger than a predetermined threshold value (CDth).

According to the above configuration, when the outside air temperature (T) is in the predetermined low temperature range (−5° C. to +5° C.) where wet snow with high moisture content tends to fall, and the dirt determination value (CD) reaches the predetermined threshold value (CDth) indicating that dirt such as snow adheres to the front surface member (FP), the heating control that energizes the heater (30) is executed. With the above, the heating control can be properly executed in a situation where snow melting of the front surface member (FP) is required, whereby it is possible to reliably suppress degradation of the detection performance of the radar (20).

In another aspect of the present disclosure, the heater control unit (42, 43) executes the heating control even when the dirt determination value (CD) is less than the threshold value (CDth) in a case where the outside air temperature (T) is in the low temperature range (−5° C. to +5° C.) and a wiper device (12) that wipes an outer surface of a windshield (11) of the vehicle (10) is activated, and executes the heating control when the dirt determination value (CD) reaches or exceeds the threshold value (CDth) in a case where the outside air temperature (T) is in the low temperature range (−5° C. to +5° C.) and the wiper device (12) is not activated.

According to the aspect above, when the wiper device (12) is activated in a situation where the outside air temperature (T) is in the predetermined low temperature range (−5° C. to +5° C.), the heater (30) is energized even when the dirt determination value (CD) is less than the predetermined threshold value (CDth), whereby the front surface member (FP) can be effectively heated before wet snow accumulates on the front surface member (FP).

Further, according to the aspect above, when the outside air temperature (T) is in the predetermined low temperature range (−5° C. to +5° C.) and the dirt determination value (CD) reaches the predetermined threshold value (CDth), the heater (30) is energized even when the wiper device (12) is not activated. With the above, the heating control can be properly executed in a situation where snow melting of the front surface member (FP) is required when the wiper device (12) is not activated when the vehicle (10) is used while wet snow accumulates on the front surface member (FP) before the vehicle (10) is used, for example, whereby it is possible to reliably suppress degradation of the detection performance of the radar (20).

In another aspect of the present disclosure, the heater control unit (42, 43) calculates a resistance value of the heater (30) based on a voltage value and a current value of the heater (30) detected while the heating control is being executed, calculates a temperature of the heater (30) based on the calculated resistance value, and executes overheat suppression control to stop energization of the heater (30) for a predetermined period of time when the temperature calculated while the heating control is being executed reaches a predetermined threshold temperature.

According to the aspect above, it is possible to suppress the heater (30) from being heated beyond the threshold temperature by the heating control, whereby it is possible to effectively suppress thermal degradation of the heater (30).

In the above description, the symbols used in the embodiment are bracketed for the component requirements of the disclosure corresponding to the embodiment to help understanding of the disclosure. However, each component requirement of the disclosure is not limited to the embodiment specified by the above symbols.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a vehicle according to the present embodiment as viewed from the front;

FIG. 2 is a functional block diagram schematically showing a control device according to the present embodiment;

FIG. 3 is a flowchart illustrating the routine of a calculation process of a dirt determination value according to the present embodiment;

FIG. 4 is a flowchart illustrating the routine of a snow melting demand determination process according to the present embodiment;

FIG. 5 is a flowchart illustrating the routine of heating control according to the present embodiment; and

FIG. 6 is a flowchart illustrating the routine of a snow melting demand determination process according to a modification.

### DETAILED DESCRIPTION OF EMBODIMENTS

Hereinafter, a control device, a control method, and a program according to the present embodiment will be described with reference to the drawings. The identical parts are assigned with identical signs, and names and functions thereof are the same. Therefore, a detailed description of the above parts will not be repeated.

Schematic Diagram

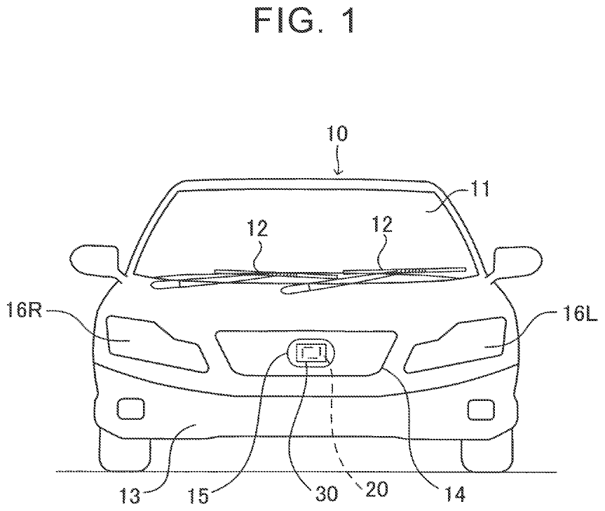

FIG. 1 is a schematic diagram of a vehicle 10 according to the present embodiment as viewed from the front. The vehicle 10 includes a windshield 11. The windshield 11 is equipped with a wiper device 12 for wiping the outer surface of the windshield 11.

A front bumper 13 extending in the vehicle width direction is attached to the front portion of the vehicle 10. Further, right and left headlights 16R, 16L are provided above the front bumper 13 in the front portion of the vehicle 10. In the front portion of the vehicle 10, a front grille 14 is provided between the right and left headlights 16R, 16L to let in the driving wind. An emblem 15 as a decorative component is provided at substantially the center of the front grille 14 in the vehicle width direction.

The vehicle 10 is equipped with a millimeter wave radar 20 that detects an object present in the area in front of the vehicle 10. The millimeter wave radar 20 irradiates radio waves in the millimeter wave band and receives the reflected waves reflected by the object present within the irradiation range. The millimeter wave radar 20 acquires the relative position (direction, distance) and the relative speed of the vehicle 10 and the object based on the phase difference between the millimeter waves irradiated and the reflected waves received, the attenuation level of the reflected waves, and the time from transmission of the millimeter waves to reception of the reflected waves. The relative position and the relative speed of the object acquired by the millimeter wave radar 20 are used, for example, for driver assistance control of the vehicle 10. As the driver assistance control, the adaptive cruise control (ACC), the lane tracing assist (LTA), the lane change assist (LCA), etc., are exemplified.

The millimeter wave radar 20 is located behind the emblem 15 in the illustrated example. The millimeter wave radar 20 can be positioned behind plastic members constituting the front surface of the vehicle 10, such as the front bumper 13, the front grille 14, the emblem 15, radome, etc. (hereafter correctively and simply referred to as a front surface member FP). In the present embodiment, the front surface member FP above is made of radio wave permeable materials that transmit millimeter waves irradiated from the millimeter wave radar 20.

The millimeter waves irradiated from the millimeter wave radar 20 penetrate the front surface member FP and reach the object, and the reflected waves reflected by the object penetrate the front surface member FP and are received by the millimeter wave radar 20. Therefore, when wet snow containing moisture adheres to or accumulates on the front surface member FP, the wet snow affects the radio wave transmissivity, thereby causing deterioration of the performance of the millimeter wave radar 20. In the present embodiment, a heater 30 is provided for the front surface member FP. The heater 30 heats the front surface member FP to melt the snow on the front surface member FP.

The heater 30 is, for example, an electric heating wire. When electric power is supplied, the electric heating wire heats the front surface member FP by generating heat. The heater 30 may be embedded in the front surface member FP or mounted on the back surface (rear surface) of the front surface member FP. The heat generated by the heater 30 heats the front surface member FP, thereby melting and removing snow when snow accumulates on the front surface member FP, or suppressing snow from adhering to the front surface member FP when snow does not accumulate on the front surface member FP.

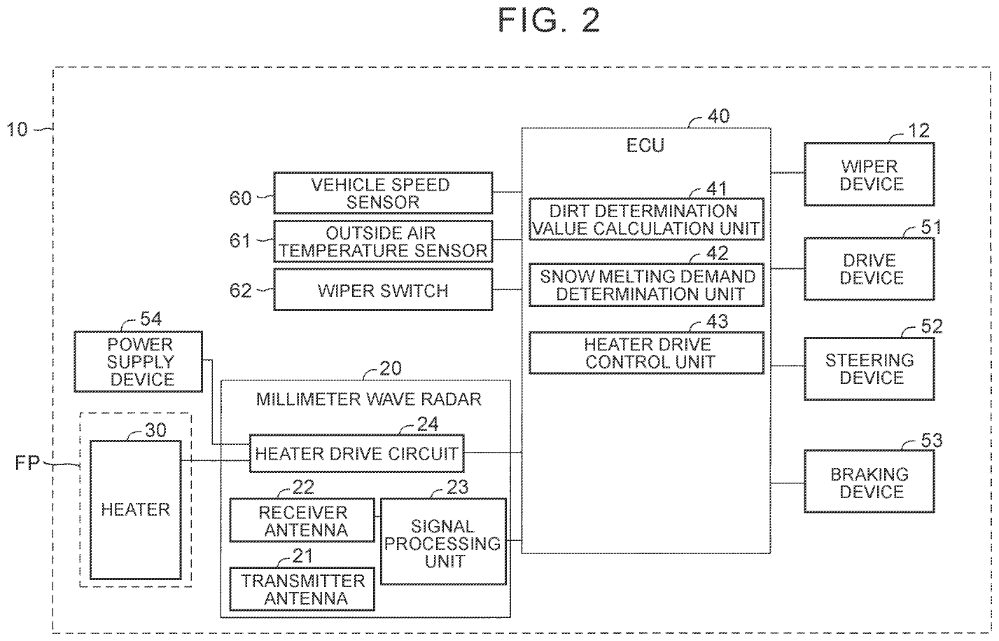

As shown in FIG. 2, the millimeter wave radar 20 includes a transmitter antenna 21 that transmits millimeter waves, a receiver antenna 22 that receives reflected waves, a signal processing unit 23 that performs fast Fourier transform (FFT) processing, a heater drive circuit 24 that controls driving of the heater 30, and the like. The vehicle 10 is equipped with an ECU 40, a drive device 51, a steering device 52, a braking device 53, a power supply device 54, and the like.

The ECU 40 includes a microcomputer as a main unit. “ECU” is an abbreviation of an electronic control unit. The microcomputer includes a central processing unit (CPU), a read-only memory (ROM), a random access memory (RAM), an interface, and the like. The CPU realizes various functions by executing an instruction (a program, a routine) stored in the ROM. The program is stored in a storage medium. The ECU 40 is the central control unit that executes various controls of the vehicle 10. Therefore, the drive device 51, the steering device 52, the braking device 53, a vehicle speed sensor 60, an outside air temperature sensor 61, the wiper device 12, a wiper switch 62, the signal processing unit 23 of the millimeter wave radar 20, the heater drive circuit 24, and the like are communicably connected to the ECU 40.

The drive device 51 generates a driving force to be transmitted to drive wheels of the vehicle 10. As the drive device 51, for example, an engine and an electric motor are exemplified. In the present embodiment, the vehicle 10 is any of a hybrid electric vehicle (HEV), a plug-in hybrid electric vehicle (PHEV), a fuel cell electric vehicle (FCEV), a battery electric vehicle (BEV), and an engine vehicle. The steering device 52 is, for example, an electric power steering device that applies a steering force to the wheels of the vehicle 10. The braking device 53 is, for example, a disc brake device that applies a braking force to the wheels of the vehicle 10. The power supply device 54 is, for example, a battery or an alternator that supplies electric power to electrical components, accessories, and the like installed in the vehicle 10.

The vehicle speed sensor 60 detects a traveling speed (vehicle speed V) of the vehicle 10 and transmits the detected vehicle speed V to the ECU 40. The vehicle speed sensor 60 may be a wheel speed sensor. The outside air temperature sensor 61 detects an outside air temperature T around the vehicle 10, and transmits the detected outside air temperature T to the ECU 40.

The wiper switch 62 is a switch for activating the wiper device 12 and is located, for example, on a steering column of the vehicle 10 (not shown). The wiper switch 62 is configured to be selectively operable at a plurality of operating positions, for example, an “OFF position” to deactivate the wiper device 12, an “AUTO position” to activate the wiper device 12 when the rain sensor (not shown) detects raindrops, wet snow, etc., a “LOW position” to operate the wiper device 12 at low speed, and a “HIGH position” to operate the wiper device 12 at high speed.

The wiper switch 62 transmits a signal corresponding to the operating position to the ECU 40. The ECU 40 controls the operation of the wiper device 12 in accordance with the received signals. The signal transmitted to the ECU 40 when the wiper switch 62 is operated in the “OFF position” will be hereinafter referred to as a “wiper OFF signal”. Further, the signal transmitted to the ECU 40 when the wiper switch 62 is operated in any of the AUTO position, the LOW position, and the HIGH position will be collectively and simply referred to as a “wiper ON signal”.

The heater drive circuit 24 includes a relay (not shown). The relay in the heater drive circuit 24 selectively switches between an energized state and a de-energized state in response to an instruction signal from the ECU 40. The case where the relay is energized will be hereinafter referred to as the “ON state” of the heater drive circuit 24, and the case where the relay is de-energized will be hereinafter referred to as the “OFF state” of the heater drive circuit 24. When the heater drive circuit 24 is in the ON state, electric power is supplied from the power supply device 54 to the heater 30, and the heater 30 generates heat. On the other hand, when the heater drive circuit 24 is in the OFF state, the connection between the power supply device 54 and the heater 30 is disconnected and no electric power is supplied to heater 30.

Heating Control

Next, heating control by the heater 30 will be described. When a focus is placed on functions of the ECU 40, the ECU 40 includes a dirt determination value calculation unit 41, a snow melting demand determination unit 42, a heater drive control unit 43 as a part of functional elements. The functional elements above are described as being included in the ECU 40 that is a single piece of hardware. However, any part of the functional elements may be provided in an ECU separate from the ECU 40. Further, a part of the functional elements of the ECU 40 can also be provided in an external information processing device or the like that is communicable with the vehicle 10.

The dirt determination value calculation unit 41 calculates a dirt determination value CD that is an index for determining whether there is a dirt on the front surface member FP. When dirt such as snow adheres to the front surface member FP, a part of the radio waves transmitted from the transmitter antenna 21 are reflected by the dirt adhering to the front surface member FP (the boundary surface between the front surface member FP and the dirt) and is received by the receiver antenna 22. On the other hand, when dirt such as snow does not adhere to the front surface member FP, the radio waves transmitted from the transmitter antenna 21 are transmitted through the front surface member FP and radiated. Therefore, there is almost no reflection from the front surface member FP. In other words, when there is the dirt such as snow on the front surface member FP, the receiver antenna 22 receives radio waves reflected in a short distance, and the reception level of radio waves received by the receiver antenna 22 increases as compared to when there is no dirt on the front surface member FP. The dirt determination value calculation unit 41 can calculate the dirt determination value CD using a known method based on the reception level of the radio waves received by the receiver antenna 22.

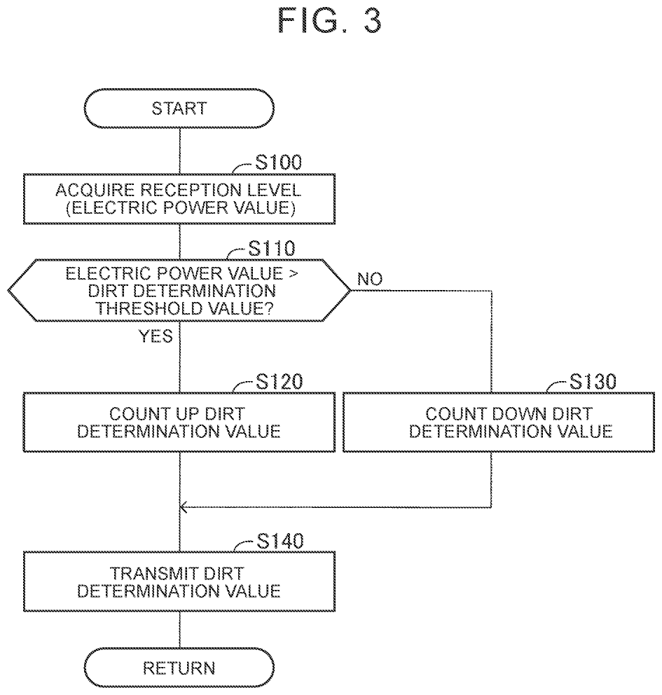

An example of the calculation process executed by the dirt determination value calculation unit 41 will be described based on the flowchart shown in FIG. 3.

The routine shown in FIG. 3 starts when the ignition switch or the power switch of the vehicle 10 is turned on and the millimeter wave radar 20 is initiated. In step S100, the dirt determination value calculation unit 41 acquires the reception level (electric power value) of the radio waves received by the receiver antenna 22 from the signal processing unit 23. Next, in step S110, the dirt determination value calculation unit 41 determines whether the acquired electric power value exceeds a dirt determination threshold value that is preset. When the electric power value exceeds the dirt determination threshold value (Yes), the dirt determination value calculation unit 41 advances the process to step S120 and counts up the count value (dirt determination value) CD of a dirt determination counter. On the other hand, when the electric power value does not exceed the dirt determination threshold value (No), the dirt determination value calculation unit 41 advances the process to step S130 and counts down the count value (dirt determination value) CD of the dirt determination counter. In step S140, the dirt determination value calculation unit 41 transmits the dirt determination value CD that is counted up or down to the snow melting demand determination unit 42, and then temporarily terminates (returns) the present routine.

The snow melting demand determination unit 42 determines whether heating of the front surface member FP by the heater 30 is required, that is, whether the snow melting demand is high. In general, wet snow with high moisture content that falls when the outside air temperature is, for example, −5° C. to +5° C. has a tendency to adhere to the outer surface of vehicle 10, such as the front surface member FP. Therefore, when wet snow as described above adheres to or accumulates on the front surface member FP, the wet snow affects the radio wave transmissivity, thereby causing deterioration of the detection performance of the millimeter wave radar 20. On the other hand, dry snow with low moisture content that falls when the outside air temperature is, for example, lower than −5° C. has a tendency not to adhere to the outer surface of the vehicle 10. Further, the driver activates the wiper device 12 when wet snow that easily adheres to the windshield 11 is falling. However, when dry snow is falling, the dry snow is difficult to adhere to the windshield 11, and thus the driver is not likely to activate the wiper device 12.

The snow melting demand determination unit 42 first determines whether a first condition in which the outside air temperature T detected by the outside air temperature sensor 61 is in a predetermined low temperature range where wet snow with high moisture content tends to fall (e.g. −5° C. to +5° C.) is satisfied. When the outside air temperature T is lower than the predetermined low temperature range, the snow quality is the dry snow that is difficult to deposit even when it is snowing. When the outside air temperature T is higher than the predetermined low temperature range, it is considered to be raining. Therefore, when the first condition is not satisfied, the snow melting demand determination unit 42 determines that the snow melting demand is low (not high). The predetermined low temperature range is not limited to the range from −5° C. to +5° C. shown in the example, but can be set to a value such as −5° C. to +3° C., for example, as appropriate to the concrete specifications of the vehicle 10 and the environment under which the vehicle 10 is used.

When the first condition is satisfied, the snow melting demand determination unit 42 determines whether the ECU 40 receives the wiper ON signal from the wiper switch 62 to determine whether a second condition is satisfied. When the outside air temperature T is in the predetermined low temperature range and the driver activates the wiper device 12 (i.e., the wiper ON signal is received), it can be presumed that wet show that tends to adhere to the windshield 11 and the front surface member FP is falling. Therefore, when the first condition is satisfied and the second condition is also satisfied, the snow melting demand determination unit 42 determines that the snow melting demand is high.

When the first condition is satisfied but the second condition is not satisfied (when the wiper OFF signal is received), the wiper device 12 is not activated although the outside air temperature T is low. Therefore, it can be presumed that wet snow that easily adheres is not falling, that snow has stopped falling, or that snow is dry snow that is difficult to adhere even when snow is falling. However, even in such a situation, for example, a case where melting of show on the front surface member FP is required regardless of whether the driver activates the wiper device 12 when the driver uses the vehicle 10, such as when wet snow accumulates on the front surface member FP before the driver starts using the vehicle 10, is also presumable.

When the first condition is satisfied but the second condition is not satisfied, the snow melting demand determination unit 42 determines whether a third condition in which the dirt determination value CD transmitted from the dirt determination value calculation unit 41 is equal to or larger than a heater activation threshold value CDth that is preset is satisfied. When the third condition is not satisfied, that is, when only the first condition is satisfied, a situation in which snow does not adhere to the front surface member FP can be presumed when the outside air temperature T is simply low and no wet snow is falling. In this case, the snow melting demand determination unit 42 determines that the snow melting demand is low. On the other hand, when the third condition is satisfied, that is, the second condition is not satisfied but the first and third conditions are satisfied, it can be presumed that dirt such as wet snow adheres to or accumulates on the front surface member FP in a situation where the outside air temperature T is low, although wet snow is not falling. In this case, the snow melting demand determination unit 42 determines that the snow melting demand is high.

As described above, it is possible to appropriately identify the situation where melting of snow on the front surface member FP is required by determining that the snow melting demand is high when the dirt determination value CD reaches the heater activation threshold value CDth although the wiper device 12 is not activated at the outside air temperature T being low, even when the wiper device 12 is not activated because, for example, snow has stopped falling when the driver uses the vehicle 10 in a state where wet snow accumulates on the front surface member FP before the driver uses the vehicle 10.

The heater drive control unit 43 executes the heating control to heat the heater 30 by placing the heater drive circuit 24 in the ON state and energizing the heater 30 when the snow melting demand determination unit 42 determines that the snow melting demand is high. Further, when the snow melting demand determination unit 42 determines that the snow melting demand is low after the heater drive control unit 43 places the heater drive circuit 24 in the ON state, the heating control is terminated by placing the heater drive circuit 24 in the OFF state.

Further, when a heater temperature Th reaches a predetermined threshold temperature after the heater drive control unit 43 places the heater drive circuit 24 in the ON state, the heater drive control unit 43 executes overheat suppression control to place the heater drive circuit 24 in the OFF state for a predetermined period of time even when the snow melting demand is determined to be high. Here, for example, the threshold temperature may be set to a temperature lower than a heat resistance temperature of the electric heating wire of the heater 30 with the heat resistance temperature as the reference. Further, for example, the resistance value of the heater 30 may be calculated based on the current value and the voltage value of the heater 30 detected when the heater drive circuit 24 is in the ON state, and the heater temperature Th may be calculated based on a relationship between the calculated resistance value and the temperature. Thus, when the heater temperature Th reaches the threshold temperature, the overheat suppression control to de-energize the heater 30 is executed, whereby thermal degradation of the heater 30 can be effectively suppressed.

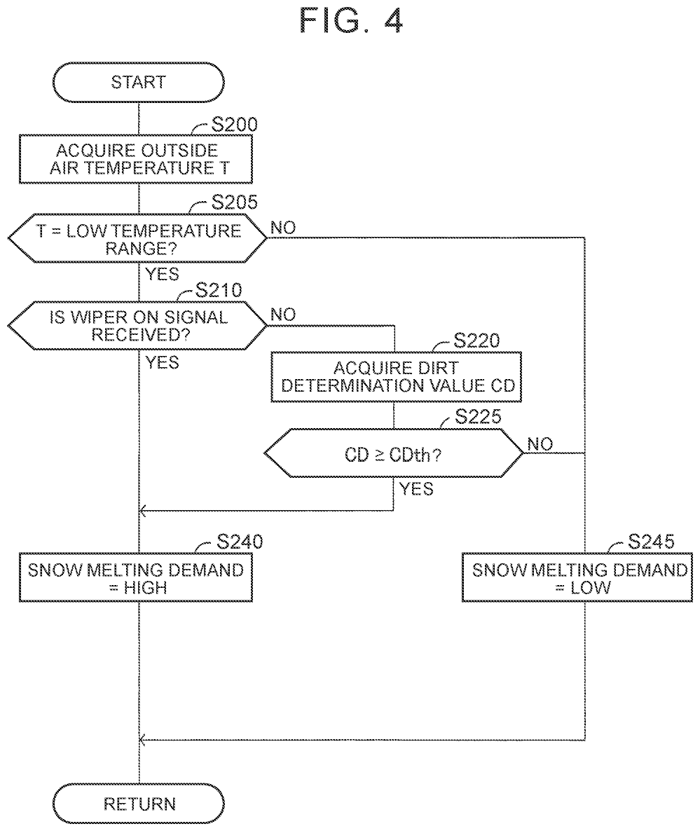

Next, the routine of the snow melting demand determination process to be executed by the CPU of the ECU 40 will be described based on the flowchart shown in FIG. 4. The present routine starts when the ignition switch or the power switch of the vehicle 10 is turned on and the millimeter wave radar 20 is initiated.

In step S200, the ECU 40 acquires the outside air temperature T detected by the outside air temperature sensor 61. Next, in step S205, the ECU 40 determines whether the first condition in which the outside air temperature T is in the predetermined low temperature range where wet snow with high moisture content is likely to fall is satisfied. When the first condition is satisfied (Yes), the ECU 40 advances the process to step S210. On the other hand, when the first condition is not satisfied (No), the ECU 40 advances the process to step S245 and determines that the snow melting demand is low, and then temporarily terminates (returns) the present routine.

In step S210, the ECU 40 determines whether the second condition in which the wiper ON signal is received from the wiper switch 62 is satisfied. When the wiper ON signal is received, that is, the second condition is satisfied (Yes), the ECU 40 advances the process to step S240. On the other hand, when the wiper OFF signal is received, that is, the second condition is not satisfied (No), the ECU 40 advances the process to step S220.

In step S240, the ECU 40 determines that the snow melting demand is high and then temporarily terminates (returns) the present routine.

In step S220, the ECU 40 acquires the dirt determination value CD. Next, in step S225, the ECU 40 determines whether the third condition in which the dirt determination value CD is equal to or larger than the heater activation threshold value CDth is satisfied. When the dirt determination value CD does not reach the heater activation threshold value CDth, that is, when the third condition is not satisfied (No), the ECU 40 advances the process to step S245 and determines that the snow melting demand is low, and then temporarily terminates (returns) the present routine. On the other hand, when the dirt determination value CD reaches or exceeds the heater activation threshold value CDth, that is, when the third condition is satisfied (Yes), the ECU 40 advances the process to step S240 and determines that the snow melting demand is high, and then temporarily terminates (returns) the present routine.

Thereafter, the ECU 40 repeats each of the processes in above steps S200 to S245 until the ignition switch or the power switch of the vehicle 10 is turned off

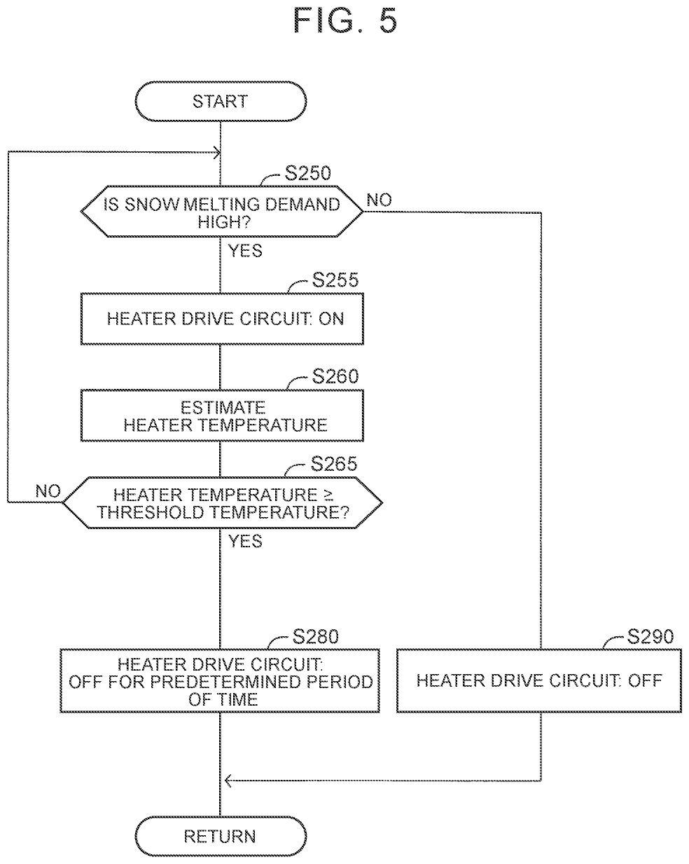

Next, the routine of the heating control to be executed by the CPU of the ECU 40 will be described based on the flowchart shown in FIG. 5. The present routine is executed in parallel with the routine of the snow melting demand determination process shown in FIG. 4 above.

In step S250, the ECU 40 determines whether the snow melting demand is determined to be high in the snow melting demand determination process described above. Specifically, when the first condition in which the outside air temperature T detected by the outside air temperature sensor 61 is in the predetermined low temperature range is satisfied, and any of the second condition in which the wiper ON signal is received from the wiper switch 62 and the third condition in which the dirt determination value CD is equal to or larger than the heater activation threshold value CDth is satisfied, the snow melting demand is determined to be high. When the snow melting demand is determined to be high (Yes), the ECU 40 advances the process to step S255 and executes the heating control to energize the heater 30 by placing the heater drive circuit 24 in the ON state. On the other hand, when the snow melting demand is determined to be low (No), the ECU 40 advances the process to step S290, and places the heater drive circuit 24 in the OFF state (or maintains the OFF state when the heater drive circuit 24 is already in the OFF state).

When the heating control is initiated in step S255, in step S260, the ECU 40 calculates the resistance value of the heater 30 based on the voltage value and the current value of the heater 30, and estimates the heater temperature Th based on the calculated resistance value. Next, in step S265, the ECU 40 determines whether the heater temperature Th reaches the predetermined threshold temperature. When the heater temperature Th does not reach the threshold temperature (No), the ECU 40 returns the process to step S250. On the other hand, when the heater temperature Th reaches the threshold temperature (Yes), the ECU 40 advances the process to step S280 and executes the overheat suppression control to place the heater drive circuit 24 in the OFF state for the predetermined period of time, and then temporarily terminates (returns) the present routine.

Thereafter, the ECU 40 repeats each of the processes in above steps S250 to S290 until the ignition switch or the power switch of the vehicle 10 is turned off

According to the present embodiment detailed above, when the first condition in which the outside air temperature T detected by the outside air temperature sensor 61 is in the predetermined low temperature range (−5° C. to +5° C.) is satisfied, and any of the second condition in which the wiper ON signal is received from the wiper switch 62 and the third condition in which the dirt determination value CD is equal to or larger than the heater activation threshold value CDth is satisfied, the heating control to energize the heater 30 is executed. In other words, a configuration is adopted in which when the wiper device 12 is activated in a situation where the outside air temperature T is in the predetermined low temperature range, the heating control is executed assuming that wet snow is falling, and when the dirt determination value CD reaches the heater activation threshold value CDth although the wiper device 12 is not activated, the heating control is executed assuming that wet snow accumulates on the front surface member FP.

In addition to the case where wet snow is falling and thus the wiper device 12 is activated, this makes it possible to properly execute the heating control when wet snow or the like adheres to or accumulates on the front surface member FP even though the wiper device 12 is not activated, whereby it is possible to reliably suppress degradation of the detection performance of the millimeter wave radar 20.

Although the control device, the control method, and the program according to the present embodiment has been described above, the present disclosure is not limited to the above embodiment, and various modifications are possible without departing from the object of the present disclosure.

Modification

For example, the determination process of the second condition may be omitted and the snow melting demand determination unit 42 may determine that the snow melting demand is high when the first condition in which the outside air temperature T is in the predetermined low temperature range (e.g., −5° C. to +5° C.) is satisfied, and the third condition in which the dirt determination value CD is equal to or larger than the preset heater activation threshold value CDth is satisfied. The details of a modification will be hereinafter described.

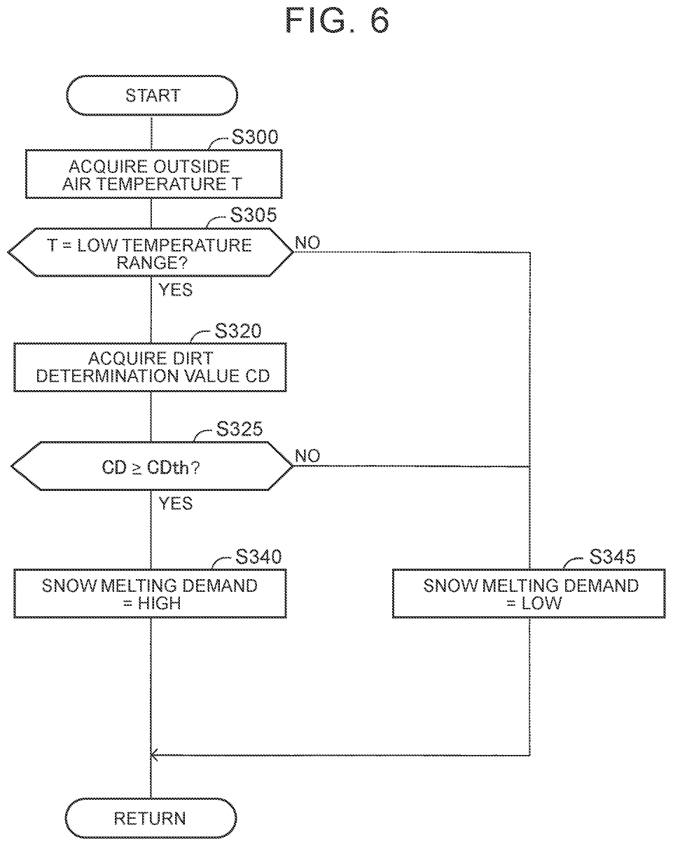

FIG. 6 is a flowchart showing the routine of a snow melting demand determination process according to the modification. Note that, the heating control is the process similar to the routine shown in FIG. 5, and therefore the description will be omitted.

In step S300, the ECU 40 acquires the outside air temperature T detected by the outside air temperature sensor 61. Next, in step S305, the ECU 40 determines whether the first condition in which the outside air temperature T is in the predetermined low temperature range where wet snow with high moisture content tends to fall is satisfied. When the first condition is satisfied (Yes), the ECU 40 advances the process to step S320. On the other hand, when the first condition is not satisfied (No), the ECU 40 advances the process to step S345 and determines that the snow melting demand is low, and then temporarily terminates (returns) the present routine.

In step S320, the ECU 40 acquires the dirt determination value CD. Next, in step S325, the ECU 40 determines whether the third condition in which the dirt determination value CD is equal to or larger than the heater activation threshold value CDth is satisfied. When the dirt determination value CD does not reach the heater activation threshold value CDth, that is, when the third condition is not satisfied (No), the ECU 40 advances the process to step S345 and determines that the snow melting demand is low, and then temporarily terminates (returns) the present routine. On the other hand, when the dirt determination value CD reaches or exceeds the heater activation threshold value CDth, that is, when the third condition is satisfied (Yes), the ECU 40 advances the process to step S340 and determines that the snow melting demand is high, and then temporarily terminates (returns) the present routine.

Thereafter, the ECU 40 repeats each of the processes in above steps S300 to S345 until the ignition switch or the power switch of the vehicle 10 is turned off

According to the modification described above, when the dirt determination value CD reaches the heater activation threshold value CDth in a situation where the outside air temperature T is in the predetermined low temperature range where wet snow tends to fall, the heating control is executed assuming that wet snow adheres to or accumulates on the front surface member FP. This makes it possible to reliably melt snow on the front surface member FP when wet snow adheres to or accumulates on the front surface member FP regardless of the operating condition of the wiper device 12, and this makes it possible to effectively suppress degradation of the detection performance of the millimeter wave radar 20 as in the embodiment above.

Others

In the present disclosure, the millimeter wave radar 20 has been described as an example of a radar sensor. However, the present disclosure can also be widely applied to other radar sensors such as LiDAR. Further, the heater 30 is installed in the front surface member FP. However, the heater 30 may be installed in a member other than the front surface member FP (e.g., a member constituting the side surface of the vehicle 10 when the millimeter wave radar 20 is installed in a side portion of the vehicle 10) in accordance with the position where the millimeter wave radar 20 is installed.

What is claimed is:

1. A control device for a heater that is installed in at least a portion of a member constituting a part of an outer surface of a vehicle and that melts snow of the member by generating heat through energization, the portion through which a radio wave of a radar installed in the vehicle is transmitted, the control device comprising:
a dirt determination value calculation unit that calculates a dirt determination value for determining whether dirt adheres to an outer surface of the portion of the member based on a reception level of a radio wave received by the radar; and
a heater control unit that executes heating control to energize the heater when an outside air temperature is in a predetermined low temperature range and the dirt determination value is equal to or larger than a predetermined threshold value.

2. The control device according to claim 1, wherein the heater control unit
executes the heating control even when the dirt determination value is less than the threshold value in a case where the outside air temperature is in the low temperature range and a wiper device that wipes an outer surface of a windshield of the vehicle is activated, and
executes the heating control when the dirt determination value reaches or exceeds the threshold value in a case where the outside air temperature is in the low temperature range and the wiper device is not activated.

3. The control device according to claim 1, wherein the heater control unit calculates a resistance value of the heater based on a voltage value and a current value of the heater detected while the heating control is being executed, calculates a temperature of the heater based on the calculated resistance value, and executes overheat suppression control to stop energization of the heater for a predetermined period of time when the temperature calculated while the heating control is being executed reaches a predetermined threshold temperature.

4. A control method for a heater that is installed in at least a portion of a member constituting a part of an outer surface of a vehicle and that melts snow of the member by generating heat through energization, the portion through which a radio wave of a radar installed in the vehicle is transmitted, the method comprising:
calculating a dirt determination value for determining whether dirt adheres to an outer surface of the portion of the member based on a reception level of a radio wave received by the radar; and
executing heating control to energize the heater when an outside air temperature is in a predetermined low temperature range and the dirt determination value is equal to or larger than a predetermined threshold value.

5. A non-transitory storage medium storing a program for causing a computer to execute processes, the computer being included in a control device for a heater that is installed in at least a portion of a member constituting a part of an outer surface of a vehicle and that melts snow of the member by generating heat through energization, the portion through which a radio wave of a radar installed in the vehicle is transmitted, the processes comprising:
calculating a dirt determination value for determining whether dirt adheres to an outer surface of the portion of the member based on a reception level of a radio wave received by the radar; and
executing heating control to energize the heater when an outside air temperature is in a predetermined low temperature range and the dirt determination value is equal to or larger than a predetermined threshold value.
